(19) United States
(12) Patent Application Publication
(10) Pub. No.: US 2008/0044770 A1
(43) Pub. Date: Feb. 21, 2008

(54) Process for forming resist pattern, semiconductor device and manufacturing method for the same

(75) Inventors: Koji Nozaki, Kawasaki (JP); Miwa Kozawa, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/647,167

(22) Filed: Dec. 29, 2006

(30) Foreign Application Priority Data
Aug. 17, 2006 (JP) 2006-222310

(51) Int. Cl. G03C 5/00

(52) U.S. Cl. 430/311

(57) ABSTRACT

To provide a process for forming a resist pattern, which the process can adopt even ArF excimer laser light as exposure light in a patterning step, can thicken a resist pattern (e.g., a hole pattern) regardless of its size, and can reduce the size of a resist space pattern with high precision while preventing changes in the resist pattern shape, to thereby make this process easy, inexpensive and efficient while exceeding the exposure (resolution) limits of light sources of exposure devices. The process of the present invention for forming a resist pattern includes: forming a resist pattern; applying over a surface of the resist pattern a resist pattern thickening material; heating the resist pattern thickening material to thicken the resist pattern followed by development; and heating the resist pattern which has been thickened.

### CROSS-REFERENCE TO RELATED APPLICATIONS

This application is based upon and claims the benefits of the priority from the prior Japanese Patent Application No. 2006-222310 filed on Aug. 17, 2006, the entire contents of which are incorporated herein by reference.

### BACKGROUND OF THE INVENTION

1. Field of the Invention

The present invention relates to a process for forming a resist pattern, in which a fine space pattern is formed by thickening a resist pattern upon manufacturing of a semiconductor device while exceeding the exposure (resolution) limits of existing exposure devices. The present invention also relates to a semiconductor and a manufacturing method for the same.

2. Description of the Related Art

Semiconductor integrated circuits have been highly integrated, and thus LSIs and VLSIs are put into practical use. Accompanying this trend, interconnection patterns have also been downsized. A lithographic technique is of great utility in forming fine interconnection patterns. In this approach, a substrate is coated with a resist film which is then selectively exposed and developed to form a resist pattern. Subsequently, dry etching is carried out using the resist pattern as a mask, and a desired pattern (e.g., an interconnection pattern) is obtained by removing the resist pattern. Although finer interconnection patterns have been achieved at present, this lithographic technique is still strongly required in fine processing technology for sustained high productivity. For this reason, not only attempts have been made to make available deep ultraviolet lay of shorter wavelength as exposure light (i.e., light used for exposure), but various creative efforts have been made with respect to the mask pattern, light source shape, etc.

By way of example, a technology has been suggested that realizes formation of a finer pattern by using a resist pattern thickening material (also referred to as “resist swelling agent”) that is capable of providing a fine resist space pattern by thickening the resist pattern formed of existing resist material. For instance, Japanese Patent Application Laid-Open (JP-A) No. 10-73927 discloses a technique called RELACS. According to the disclosure, a KrF resist pattern is formed by exposing a KrF (krypton fluoride) resist film to KrF (krypton fluoride) excimer laser light of 248 nm wavelength, which is deep ultraviolet light. Thereafter, a water-soluble resin composition is applied over the KrF resist pattern to form a coating film. A crosslinking reaction is then allowed to take place at the interface between the coated film and KrF resist pattern with a help of residual acid present in the KrF resist pattern material, whereby the KrF resist pattern is thickened (hereinafter may be referred to as “swelled”). In this way the distance between adjacent spaces in the KrF resist pattern is reduced (or the diameter of hole is reduced in the case of a hole pattern) and a fine space pattern is formed. Thereafter, a desired pattern (e.g. interconnection pattern) having the same dimension as the space pattern is formed.

For the purpose of forming a finer interconnection pattern, as exposure light, those with a shorter wavelength than KrF (krypton fluoride) excimer laser light (wavelength=248 nm), such as ArF (argon fluoride) excimer laser light (wavelength=193 nm), are desirable.

Another example includes a pattern-minimizing technique called thermal flow. In this technique, after forming a resist pattern, the resist is heat-treated at a temperature that causes fluidization of resin, thereby fluidizing the resist pattern and further reducing the resist space pattern size.

Since the thermal flow technique utilizes fluidization of resist resin for the further reduction of the resist space pattern size, in general, the greater the volume of the resist pattern portion, the easier it is to achieve greater reduction in the resist space pattern size rather than using such a resist pattern thickening material.

Acrylic-based resists suitable for ArF light are different in resin composition from conventional KrF resists and thus are relatively difficult to fluidize at conventional temperatures, or relatively low temperatures. For this reason, when the resist pattern 110 formed on the substrate 100 is heated moderately, it merely results in a small change in the edge shape of the resist pattern 110 as shown in FIG. 18A, and thus reduction of the resist space pattern 102 size becomes difficult. Moreover, when the heating temperature is raised to increase the amount of reduction in the resist space size, the resist resin is fluidized to undesirably increase the likelihood of deformation (blunting) of the upper edges of the resist pattern 110, the reduction in the resist pattern 110 thickness, etc, as shown in FIG. 18B.

Meanwhile, in a finer resist pattern with small resist pattern portions, such as a pattern of densely arranged lines of 100 nm width or less, the constituent resist resin that undergoes fluidization is small in volume and thus narrowing of the resist space becomes difficult.

Japanese Patent Application Laid-Open (JP-A) No. 2000-58506 suggests a technique in which after formation of a resist space pattern for a KrF resist pattern using the RELACS technique, a finer resist space pattern is formed by thermal flow.

Along with the recent increase in packing densities of semiconductor integrated circuits, however, it is demanded to use ArF (argon fluoride) excimer laser light (wavelength=193 nm) or the like to realize formation of a finer interconnection pattern, as described above.

A development of a technology has been demanded that can make ArF excimer laser light applicable as exposure light in a patterning step and that can reduce the resist space pattern size with high precision in an ArF resist, a resist where formation of a finer space pattern is difficult with the thermal flow technique, while preventing changes in the resist pattern shape, to thereby realize easy, inexpensive formation of a fine space pattern or interconnection pattern.

It is an object of the present invention to solve the foregoing conventional problems and to achieve the object described below.

Specifically, it is an object of the present invention to provide a process for forming a resist pattern, which the process can adopt even ArF excimer laser light as exposure light in a patterning step, can thicken a resist pattern (e.g., a hole pattern) regardless of its size, and can reduce the size of a resist space pattern with high precision while preventing changes in the resist pattern shape, to thereby make this process easy, inexpensive and efficient while exceeding the exposure (resolution) limits of light sources of existing exposure devices.

It is another object of the present invention to provide (1) a method for manufacturing a semiconductor device, which the method can adopt even ArF excimer laser light as exposure light in a patterning step, can reduce the size of a resist space pattern with high precision while exceeding the exposure (resolution) limits of light sources of exposure devices, and can manufacture high-performance semiconductor devices with a fine interconnection pattern in large quantities, and (2) a semiconductor device manufactured by the method.

The present inventors have conducted extensive studies to overcome the foregoing problems, and they have established the following: After applying a resist pattern thickening material to an ArF resist pattern—a pattern where the resist space pattern reduction by thermal flow is difficult compared to a conventional KrF resist—to thicken the ArF resist pattern, the resin of the thickened ArF resist pattern is fluidized by thermal flow and thereby the resist space pattern size is reduced with high precision while preventing changes in the resist pattern shape. This technology can be suitably applied to memory devices such as FLASH memories and DRAMs, where many equally-shaped repetitive lines are formed and thus a finer resist space pattern is required.

In addition, the present inventors have established that by using as the resist pattern thickening material a material developed by the present inventors, which the material contains benzyl alcohol as a reagent and is free from a crosslinking agent, the resist pattern can be thickened regardless of its size while imparting excellent etching resistance, thereby completing the present invention.

### SUMMARY OF THE INVENTION

The following is the means for solving the foregoing problems:

The process of the present invention for forming a resist pattern includes: forming a resist pattern; applying over a surface of the resist pattern a resist pattern thickening material; heating the resist pattern thickening material to thicken the resist pattern followed by development; and heating the resist pattern which has been thickened, wherein the resist pattern thickening material comprises a resin and a compound represented by the following general formula (1):

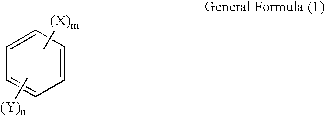

where X is a functional group represented by the following structural formula (1), Y is at least one of hydroxyl group, amino group, alkyl group-substituted amino group, alkoxy group, alkoxycarbonyl group and alkyl group and the number of the substituents is an integer of 0 to 3, m is an integer of 1 or greater, and n is an integer of 0 or greater

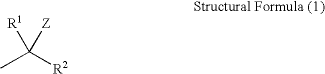

where R¹ and R² may be identical or different and each is a hydrogen atom or substituent, Z is at least one of hydroxyl group, amino group, alkyl group-substituted amino group and alkoxy group and the number of the substituents is an integer of 0 to 3.

When the resist pattern thickening material is applied over the resist pattern and heated in the resist pattern thickening step of the resist pattern forming process, the resist pattern thickening material infiltrates the resist pattern at their interface to interact (mix) with the resist pattern material. At this point the resist pattern thickening material has excellent compatibility with the resist pattern and thus results in an efficient formation of a surface layer (mixing layer), a layer in which the resist pattern thickening material and the resist pattern are mixed, on the surface of the resist pattern which now serves as an inner layer. In this way the resist pattern is efficiently thickened by means of the resist pattern thickening material. The resist pattern thus thickened (hereinafter referred to as “swelled” in some cases) is uniformly thickened by means of the resist pattern thickening material (hereinafter such a resist pattern may be referred to as “thickened resist pattern” in some cases). Note that since the resist pattern thickening material contains a compound represented by the general formula (1), it thickens the resist pattern uniformly regardless of the size or constitutional material of the resist pattern. This means that thickening capability of the resist pattern thickening material is less dependent on the size or type of the resist pattern. Furthermore, since the compound represented by the general formula (1) contains an aromatic ring, the resist pattern thickening material is excellent in terms of etching resistance.

Subsequently, the thickened resist pattern is further heated (baked) in the heating step. At this point, the resin constituting the resist pattern is fluidized, whereby spaces between adjacent pattern lines are narrowed. As a result, it is made possible to easily form a thickened resist pattern with high resolution, which is then used for the formation of a line-space pattern in an interconnection layer of LOGIC LSIs where various sizes of resist patterns are utilized in addition to contact hole patterns, and for the formation of multiple equally-shaped repetitive lines in memory devices such as FLASH memories and DRAMs.

The method of the present invention for manufacturing a semiconductor device includes: forming a resist pattern on a surface of a workpiece by means of the method of the present invention for forming a resist pattern; and patterning the surface by etching using the resist pattern as a mask.

In the resist pattern forming step of this manufacturing method a resist pattern is formed on a surface of a workpiece, where an interconnection pattern or the like is to be formed. This resist pattern is a thickened resist pattern formed by the process of the present invention for forming a resist pattern, and thus is uniformly thickened regardless of its size. Accordingly, the size of the resulting resist space pattern in the thickened resist pattern is further reduced with high precision.

In the patterning step, the surface is then patterned by etching using the resist patterned that has been thickened in the resist pattern forming step, whereby the surface is finely patterned with high dimension precision, allowing efficient manufacture of a high-performance, high-quality semiconductor device with a very fine pattern (e.g., an interconnection pattern) formed with high dimension precision and accuracy.

The semiconductor device of the present invention is characterized in that it is manufactured by the manufacturing method of the present invention for manufacturing a semiconductor device. The semiconductor device is of high quality and high performance and has a very fine pattern (e.g., an interconnection pattern) formed with high dimension precision and accuracy.

### BRIEF DESCRIPTION OF THE DRAWINGS

FIG. 1 is a schematic view for explaining an example of the process of the present invention for forming a resist pattern, showing a state where a resist film has been formed.

FIG. 2 is a schematic view for explaining an example of the process of the present invention for forming a resist pattern, showing a state where the resist film has been patterned to form a resist pattern.

FIG. 3 is a schematic view for explaining an example of the process of the present invention for forming a resist pattern, showing a state where a resist pattern thickening material has been applied over the resist pattern surface.

FIG. 4 is a schematic view for explaining an example of a process of the present invention for forming a resist pattern, showing a state where the resist pattern thickening material has been mixed with, and infiltrated the resist pattern surface.

FIG. 5 is a schematic view for explaining an example of a process of the present invention for forming a resist pattern, showing a state where the resist pattern thickening material has been developed off.

FIG. 6 is a schematic view for explaining an example of a process of the present invention for forming a resist pattern, showing a state where the thickened resist pattern has been further heated.

FIG. 7 is a plot of heat treatment temperature vs. resist space pattern size in Example 1 (thickened resist pattern) and Comparative Example 1 (untreated resist pattern).

FIG. 8 shows top SEM pictures of holes formed in Example 1 and Comparative Example 1.

FIG. 9 is a schematic view for explaining an example of a process of the present invention for forming a resist pattern, showing a state where an interlayer dielectric film has been formed on a silicon substrate.

FIG. 10 is a schematic view for explaining an example of a process of the present invention for forming a resist pattern, showing a state where a titanium film has been formed on the interlayer dielectric film shown in FIG. 9.

FIG. 11 is a schematic view for explaining an example of a process of the present invention for forming a resist pattern, showing a state where a resist film is formed on the titanium film and a hole pattern is formed on the titanium film.

FIG. 12 is a schematic view for explaining an example of a process of the present invention for forming a resist pattern, showing a state where the hole pattern has been also formed in the interlayer dielectric film.

FIG. 13 is a schematic view for explaining an example of a process of the present invention for forming a resist pattern, showing a state where a Cu film has been formed on the interlayer dielectric film provided with the hole pattern.

FIG. 14 is a schematic view for explaining an example of a process of the present invention for forming a resist pattern, showing a state where deposited copper has been removed from the interlayer dielectric film except from the hole pattern.

FIG. 15 is a schematic view for explaining an example of a process of the present invention for forming a resist pattern, showing a state where an interlayer dielectric film is formed on the Cu plug formed inside of the hole pattern and on the interlayer dielectric film.

FIG. 16 is a schematic view for explaining an example of a process of the present invention for forming a resist pattern, showing a state where a hole pattern has been formed on the interlayer dielectric film as a surface layer and a Cu plug has been formed therein.

FIG. 17 is a schematic view for explaining an example of a process of the present invention for forming a resist pattern, showing a state where a three-stage interconnection has been formed.

FIG. 18A is a schematic view for explaining a trouble that occurs when a resist pattern formed of an ArF resist has been subjected to a thermal flow process at conventional temperatures.

FIG. 18B is a schematic view for explaining a trouble that occurs when a resist pattern formed of an ArF resist has been subjected to a thermal flow process at high temperatures.

### DESCRIPTION OF THE PREFERRED EMBODIMENTS

### (Process for Forming a Resist Pattern)

The process of the present invention for forming a resist pattern includes at least a resist pattern thickening step and a heating step, and further includes additional step(s) selected appropriately, where necessary.

### <Resist Pattern Thickening Step>

The resist pattern thickening step is a step in which after forming a resist pattern, a resist pattern thickening material is applied over a surface of the resist pattern, followed by heating and development for thickening of the resist pattern.

### —Resist Pattern—

The material of the resist pattern is not particularly limited and can be appropriately selected from known resist materials; they may be positive or negative type. Examples include g-line resists, i-line resists, KrF resists, ArF resists, F₂ resists, electron beam resists, EUV (extreme ultraviolet) resists and the like that can be patterned using g-line, i-line, KrF excimer laser beam, ArF excimer laser beam, F₂ excimer laser beam, electron beam, and the like, respectively. These resists may be chemically amplified types, or non-chemically amplified types. Among them, KrF resists, ArF resists and resists containing acrylic resin are preferable. In addition, ArF resists and resists containing acrylic resin are more preferable, for which there remains a pressing need to improve the resolution limit for finer patterning and increased throughput.

Specific examples of the materials of the resist pattern include novolac resists, PHS resists, acrylic resists, cycloolefin-maleic acid anhydrate (COMA) resists, cycloolefin resists, and hybrid resists such as alicyclic acrylic-COMA copolymers. These resists may be modified by fluorine.

The resist pattern can be formed by a known process.

The resist pattern can be formed on a surface of a workpiece (or base), and such a surface of a workpiece (base) is not particularly limited and can be appropriately determined depending on the intended purpose. In a case where the resist pattern is to be used for the manufacture of a semiconductor device, a surface of a semiconductor substrate can be exemplified as the surface of the workpiece. Specific examples include surfaces of substrates such as silicon wafer and various oxide films.

The size, thickness, etc., of the resist pattern is not particularly limited and can be appropriately determined depending on the intended purpose. The thickness of the resist pattern, however, is generally 0.1 μm to 500 μm, though it can be appropriately determined depending on the type of workpiece surface, etching conditions, etc.

### —Resist Pattern Thickening Material—

The resist pattern thickening material contains at least a resin and one compound represented by the following general formula (1), and further contains a surfactant, a phase transfer catalyst, a water-soluble aromatic compound, a resin where an aromatic compound is contained in its part, an organic solvent and additional ingredient(s) on an as-needed basis, all of which are appropriately selected where necessary.

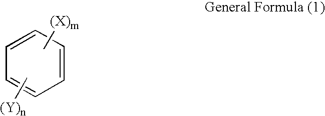

where X is a functional group represented by the following structural formula (1), Y is at least one of hydroxyl group, amino group, alkyl group-substituted amino group, alkoxy group, alkoxycarbonyl group and alkyl group and the number of the substituents is an integer of 0 to 3, m is an integer of 1 or greater, and n is an integer of 0 or greater

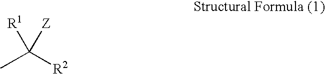

where R¹ and R² may be identical or different and each is a hydrogen atom or substituent, Z is at least one of hydroxyl group, amino group, alkyl group-substituted amino group and alkoxy group and the number of the substituents is an integer of 0 to 3

The resist pattern thickening material is preferably water soluble or alkali soluble; its water solubility is not particularly limited and can be appropriately set depending on the intended use. For example, the resist pattern thickening material preferably has a solubility of at least 0.1 g per 100 g of 25° C. water.

Meanwhile, the alkali solubility of the resist pattern thickening material is not particularly limited and can be appropriately set depending on the intended use. For example, the resist pattern thickening material preferably has a solubility of at least 0.1 g per 100 g of 2.38% (by mass) aqueous solution of tetramethylammoniumhydroxide (TMAH) at a temperature of 25° C.

The form in which the resist pattern thickening material of the present invention is present is not particularly limited; it may be present in the form of an aqueous solution, colloidal solution or emulsion solution. Preferably, the resist pattern thickening material is present in the form of aqueous solution.

### —Resin—

The resin is not particularly limited and can be appropriately selected depending on the intended use. However, water-soluble resins or alkali-soluble resins are preferably used.

For the resin, resins that contain two or more polar groups are preferable in light of their excellent water solubility or alkali solubility.

The polar group is not particularly limited and can be appropriately selected depending on the intended use; suitable examples include hydroxyl group, amino group, sulfonyl group, carbonyl group, carboxyl group and derivative groups thereof. These groups may be contained in the resin singly or in combination.

If the resin is a water-soluble resin, it preferably has a solubility of at least 0.1 g per 100 g of 25° C. water.

Examples of the water-soluble resin include polyvinyl alcohol, polyvinyl acetal, polyvinyl acetate, polyacrylic acid, polyvinylpyrrolidone, polyethyleneimine, polyethyleneoxide, styrene-maleic acid copolymers, polyvinylamine, polyallylamine, oxazoline group-containing water-soluble resins, water-soluble melamine resins, water-soluble urea resins, alkyd resins and sulfonamide resins.

If the resin is an alkali-soluble resin, it preferably has a solubility of at least 0.1 g per 100 g of 2.38% (by mass) aqueous solution of tetramethylammoniumhydroxide (TMAH) at a temperature of 25° C.

Examples of the alkali-soluble resins include novolac resins, vinylphenol resins, polyacrylic acid, polymethacrylic acid, poly-p-hydroxyphenylacrylate, poly-p-hydroxyphenylmethacrylate and copolymers thereof.

These resins may be used singly or in combination. Among these, polyvinyl alcohol, polyvinyl acetal and polyvinyl acetate are preferable. More preferably, the resin contains 5-40% by mass of polyvinyl acetal.

In the resist pattern thickening material, at least a part of the resin may contain a cyclic structure, and use of such a resin is advantageous because excellent etching resistance can be imparted to the resist pattern thickening material.

The resin, at least a part of which contains a cyclic structure, may be used singly or in combination, or may be used together with the foregoing resins.

The resin at least a part of which contains a cyclic structure is not particularly limited and can be appropriately selected; examples include polyvinyl aryl acetal resins, polyvinyl aryl ether resins, polyvinyl aryl ester resins, and derivatives thereof, and a preferable example is at least one selected from the above resins or derivatives. Among these, those bearing an acetyl group are most preferable in view of their moderate water or alkali solubility.

The polyvinyl aryl acetal resins are not particularly limited and can be appropriately selected in accordance with the intended purpose; examples include β-resorcin acetal.

The polyvinyl aryl ether resins are not particularly limited and can be appropriately selected in accordance with the intended purpose; examples include 4-hydroxybenzyl ether.

The polyvinyl aryl ester resins are not particularly limited and can be appropriately selected in accordance with the intended purpose; examples include benzoic esters.

The production process for the polyvinyl aryl acetal resins is not particularly limited and can be appropriately selected in accordance with the intended purpose. For example, a production process that utilizes known polyvinyl acetal-preparing reactions can be suitably used. For example, the production process is one in which polyvinyl alcohol is allowed to react with a stoichiometric quantity of an aldehyde in the presence of acidic catalyst. More specifically, suitable processes are those disclosed in U.S. Pat. No. 5,169,897, U.S. Pat. No. 5,262,270, JP-A No. 05-78414, etc.

The production process for the polyvinyl aryl ether resins is not particularly limited and can be appropriately selected in accordance with the intended purpose. For example, copolymerization of vinyl acetate with a corresponding vinyl aryl ether monomer, and etherification (Williamson Ether Synthesis) of polyvinyl alcohol with a halogenated alkyl group-containing aromatic compound in the presence of basic catalyst, can be exemplified. More specifically, suitable processes are those disclosed in JP-A Nos. 2001-40086, 2001-181383, 06-116194, etc.

The production process for the polyvinyl aryl ester resins is not particularly limited and can be appropriately selected in accordance with the intended purpose. For example, copolymerization of vinyl acetate with a corresponding vinyl aryl ester monomer, and etherification of polyvinyl alcohol with an aromatic carboxylic acid halide in the presence of basic catalyst, can be exemplified.

The cyclic structure in the foregoing resins is not particularly limited and can be appropriately selected in accordance with the intended purpose; it can be any of a monocyclic structure (e.g., benzene), a polycyclic structure (e.g., bisphenol) and a condensed ring structure (e.g., naphthalene). More specifically, suitable examples include aromatic compounds, alicyclic compounds and heterocyclic compounds. The resins at least a part of which contains a cyclic structure may contain one or more of these cyclic structures.

Examples of the aromatic compounds include polyvalent phenol compounds, polyphenol compounds, aromatic carboxylic acid compounds, naphthalene polyvalent alcohol compounds, benzophenone compounds, flavonoid compounds, porphin, water-soluble phenoxy resins, aromatic group-containing water-soluble dyes, derivatives thereof, and glycosides thereof. These aromatic compounds may be used singly or in combination.

Examples of the polyvalent phenol compounds include resorcine, resorcine[4]arene, pyrogallol, gallic acid, derivatives thereof and glycosides thereof.

Examples of the polyphenol compounds include catechin, anthocyanidin such as pelargonidin-type (4′-hydroxy), cyanidin-type (3′,4′-dihydroxy) and delphinidin-type (3′,4′,5′-trihydroxy), flavan-3,4-diol and proanthocyanidin.

Examples of the aromatic carboxylic acid compounds include salicylic acid, phthalic acid, dihydroxy benzoic acid and tannin.

Examples of the naphthalene polyvalent alcohol compounds include naphthalene diol and naphthalene triol.

Examples of the benzophenone compounds include alizarin yellow A.

Examples of the flavonoid compounds include flavone, isoflavone, flavanol, flavonone, flavonol, flavan-3-ol, aurone, chalcone, dihydrochalcone and quercetin.

Examples of the alicyclic compounds include polycycloalkanes, cycloalkanes, condensed rings, derivatives thereof and glycosides thereof. These alicyclic compounds may be used singly or in combination.

Examples of the polycycloalkanes include adamantine, norbornene, norpinane and sterane.

Examples of the cycloalkanes include cyclopentane and cyclohexane.

Examples of the condensed rings include steroids.

Suitable examples of the heterocyclic compounds include nitrogen-containing cyclic compounds such as pyrrolidine, pyridine, imidazole, oxazole, morpholine and pyrrolidone; and oxygen-containing cyclic compounds such as furans, pyrans, and polysaccharides including 5-carbon sugars and 6-carbon sugars.

The resin, at least a part of which has a cyclic structure, preferably has at least one functional group (e.g., hydroxyl, cyano, alkoxyl, carboxyl, amino, amide, alkoxycarbonyl, hydroxyalkyl, sulfonyl, acid anhydride, lactone, cyanate, isocyanate and/or ketone groups) or a sugar derivative, in view of proper water-solubility; more preferably, the resin contains at least one functional group selected from hydroxyl group, amino group, sulfonyl group, carboxylic group, and groups derived from derivatives thereof.

The molar content of the cyclic structure in the resin is not particularly limited as long as etching resistance is not reduced, and thus can be appropriately set depending on the intended purpose. If high etching resistance is required, the molar content of the cyclic structure is preferably 5 mol % or more and, more preferably, 10 mol % or more.

Note that the molar content of such a cyclic structure in the foregoing resin can be measured by NMR, for example.

The content of the foregoing resin (i.e., resin at least a part of which contains the cyclic structure(s)) in the resist pattern thickening material is not particularly limited and can be appropriately set depending on the content and/or type of the resin that contains no cyclic structures, the compound represented by the general formula (1) shown below, a surfactant, etc.

### —Compound Represented by General Formula (1)—

The compound represented by the general formula (1) is not particularly limited as long as it contains an aromatic ring and is represented by the following general formula (1), and can be appropriately selected depending on the intended purpose. Inclusion of an aromatic ring is advantageous because the resulting resist pattern thickening material can be provided with excellent etching resistance even when the resin fails to contain a cyclic structure.

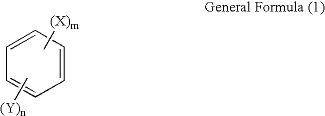

where X is a functional group represented by the following structural formula (1), Y is at least one of hydroxyl group, amino group, alkyl group-substituted amino group, alkoxy group, alkoxycarbonyl group and alkyl group and the number of the substituents is an integer of 0 to 3, m is an integer of 1 or greater, and n is an integer of 0 or greater

The integer “m” is preferably 1 because controlled rate of reaction can be readily achieved by preventing crosslinking reactions.

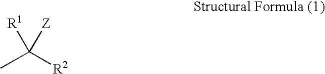

where R¹ and R² may be identical or different and each is a hydrogen atom or substituent, Z is at least one of hydroxyl group, amino group, alkyl group-substituted amino group and alkoxy group and the number of the substituents is an integer of 0 to 3.

In the structural formula (1) above, R¹ and R² are preferably hydrogen atoms. This is often advantageous in terms of water-solubility.

If R¹ and R² are substituents, such substituents are not particularly limited and can be appropriately determined depending on the intended purpose; examples include ketone (alkylcarbonyl) group, alkoxycarbonyl group and alkyl group.

Specific, preferred examples of the compounds represented by the general formula (1) include compounds having a benzylalcohol structure and compounds having a benzylamine structure. The compounds having a benzylalcohol structure are not particularly limited and can be appropriately selected depending on the intended purpose; for example, benzylalcohol and derivatives thereof are preferable. Specific examples include benzyl alcohol, 2-hydroxybenzyl alcohol (salicyl alcohol), 4-hydroxybenzyl alcohol, 2-aminobenzyl alcohol, 4-aminobenzyl alcohol, 2,4-dihydroxybenzyl alcohol, 1,4-benzenedimethanol, 1,3-benzenedimethanol, 1-phenyl-1,2-ethanediol, and 4-methoxymethylphenol.

Examples of the compounds having a benzylamine structure are not particularly limited and can be appropriately selected depending on the intended purpose; for example, benzylamine and derivatives thereof are preferable. Specific examples include benzylamine and 2-methoxybenzylamine.

These compounds may be used singly or in combination. Among these, 2-hydroxybenzylalcohol, 4-aminobenzylalcohol and the like are preferable in view of their high water-solubility, which allows the compound to be dissolved in large quantities.

The content of the compound represented by the general formula (1) in the resist pattern thickening material is not particularly limited and can be appropriately set depending on the intended purpose; for example, the content of such a compound is preferably 0.01 parts by mass to 50 parts by mass based on the total resist pattern thickening material, more preferably, 0.1 parts by mass to 10 parts by mass.

If less than 0.01 parts by mass is used, it may result in failure to obtain a desired degree of reaction, whereas if 50 parts by mass is used, the possibility that the compound is precipitated out of the solution during a coating step and/or pattern defects occur undesirably increases.

### —Surfactant—

When it is required, for example, to improve the conformability of a resist pattern thickening material with a resist pattern, to obtain a larger thickening amount of the resist pattern, to improve in-plane uniformity of the thickening effect at the interface between a resist pattern thickening material and a resist pattern, and to provide anti-forming property, the addition of the surfactant can fulfill the requirements.

The surfactant is not particularly limited and can be appropriately selected depending on the intended purpose. Examples include nonionic surfactants, cationic surfactants, anionic surfactants and amphoteric surfactants. These surfactants may be used singly or in combination. Among them, nonionic surfactants are preferred from the viewpoint that they contain no metallic ions such as sodium ion, potassium ion, and the like.

Suitable examples of the nonionic surfactants include alkoxylate surfactants, fatty acid ester surfactants, amide surfactants, alcohol surfactants, and ethylenediamine surfactants. Specific examples thereof include polyoxyethylene-polyoxypropylene condensation compounds, polyoxy alkylene alkylether compounds, polyoxy ethylene alkylether compounds, polyoxy ethylene derivative compounds, sorbitan fatty acid ester compounds, glycerine fatty acid ester compounds, primary alcohol ethoxylate compounds, phenol ethoxylate compounds, nonyl phenol ethoxylate compounds, octyl phenol ethoxylate compounds, lauryl alcohol ethoxylate compounds, oleyl alcohol ethoxylate compounds, fatty acid esters, amides, natural alcohols, ethylenediamines, and secondary alcohol ethoxylate compounds.

The cationic surfactants are not particularly limited and can be selected according to the intended purpose. Examples thereof include alkyl cationic surfactants, amide quaternary cationic surfactants and ester quaternary cationic surfactants.

The amphoteric surfactants are not particularly limited and can be selected according to the intended purpose. Examples thereof include amine oxide surfactants and betaine surfactants.

The content of the surfactant in the resist pattern thickening material is not particularly limited and can be appropriately set according to the type, content, etc., of the resin, compound represented by the general formula (1), phase transfer catalyst, etc. A suitable content of the surfactant is, for example, 0.01 parts by mass or more per 100 parts by mass of the resist pattern thickening material, preferably 0.05 parts by mass to 2 parts by mass and, more preferably, 0.08 parts by mass to 0.5 parts by mass in view of a high degree of reaction and excellent in-plane uniformity.

When the content of the surfactant is 0.01 parts by mass or less, coating properties will be increased, however, in most cases, the degree of reaction of the resist pattern thickening material with a resist pattern is little different from that of a surfactant-free resist pattern thickening material.

### —Phase Transfer Catalyst—

The phase transfer catalyst is not particularly limited and can be selected according to the intended purpose. Examples thereof include organic materials and among them, basic organic materials are particularly preferred.

When the resist pattern thickening material comprises such a phase transfer catalyst, it is advantageous in that the resist pattern is uniformly thickened regardless of its constituent material, which means that thickening properties are less depending on the identity of the resist pattern material. Note that the effect of this phase transfer catalyst will not be impaired by the presence of an acid generation agent contained in a resist pattern to be thickened by using the resist pattern thickening material.

The phase transfer catalyst is preferably water-soluble, and exhibits water-solubility of at least 0.1 g per 100 g of 25° C. water.

Specific examples of the phase transfer catalyst are crown ethers, azacrown ethers, and onium salt compounds.

The phase transfer catalysts may be used singly or in combination. Among them, onium salt compounds are preferable in view of their high solubility in water.

Examples of the crown ether and azacrown ether are 18-crown-6,15-crown-5,1-aza-18-crown-6, 4,13-diaza-18-crown-6, and 1,4,7-triazacyclononane.

The onium salt compounds are not particularly limited and can be appropriately selected according to the intended purpose; examples include quaternary ammonium salts, pyridinium salts, thiazolium salts, phosphonium salts, piperazinium salts, ephedrinium salts, quininium salts and cinchoninium salts

Examples of the quaternary ammonium salts are those that are often used as a reagent in organic synthesis: tetrabutylammonium hydrogensulfate, tetramethylammonium acetate, tetramethylammonium chloride, and the like.

Examples of the pyridinium salts include hexadecylpyridinium bromide.

Examples of the thiazolium salts include 3-benxyl-5-(2-hydroxyethyl)-4-methylthiazolium chloride.

Examples of phosphonium salts include tetrabutylphosphonium chloride.

Examples of the piperazinium salts include 1,1-dimethyl-4-phenylpiperazinium iodide.

Examples of the ephdrinium salts include ((-)-N,N-dimethylephedrinium bromide).

Examples of the quininium salts include N-benzylquininium chloride.

Examples of the cinchoninium salts include N-benzylcinchoninium chloride.

The content of the phase transfer catalyst in the resist pattern thickening material depends on the type, content, etc. of the foregoing resin and the like and thus cannot be defined flatly; however, the content can be set according to such factors. For example, a preferred content range is 10,000 ppm or less, preferably 10 ppm to 10,000 ppm, more preferably 10 ppm to 5,000 ppm and, most preferably, 10 ppm to 3,000.

If the content of the phase transfer catalyst is 10,000 ppm or less, it is advantageous in that the resist pattern, such as line-space patterns, can be thickened regardless of its size.

The content of the phase transfer catalyst can be measured by liquid chromatography, for example.

### —Water-Soluble Aromatic Compound—

The water-soluble aromatic compound is not particularly limited as long as it is an aromatic compound which exhibits water-solubility, and can be appropriately selected according to the intended purpose. Water-soluble aromatic compounds with a water-solubility of at least 1 g per 100 g of 25° C. water are preferable, and those with a water-solubility of at least 3 g per 100 g of 25° C. water are more preferable. Particularly, those with a water-solubility of at least 5 g per 100 g of 25° C. water are most preferable.

If the resist pattern thickening material comprises the water-soluble aromatic compound, this is preferable because etching resistance of the obtained resist pattern remarkably increases by virtue of the presence of a cyclic structure of the water-soluble aromatic compound.

Examples of the water-soluble aromatic compound are polyphenol compounds, aromatic carboxylic acid compounds, benzophenone compounds, flavonoid compounds, porphin, water-soluble phenoxy resins, aromatic-containing water-soluble dyes, derivatives thereof and glycosides thereof. These compounds may be used singly or in combination.

Examples of the polyphenol compounds include catechin, anthocyanidin such as pelargonidin-type (4′-hydroxy), cyanidin-type (3′,4′-dihydroxy) and delphinidin-type (3′,4′,5′-trihydroxy), flavan-3,4-diol, proanthocyanidin, resorcine, resorcine[4]arene, pyrogallol and gallic acid.

Examples of the aromatic carboxylic acid compounds include salicylic acid, phthalic acid, dihydroxy benzoic acid and tannin.

Examples of the benzophenone compounds include alizarin yellow A.

Examples of the flavonoid compounds include flavone, isoflavone, flavanol, flavonone, flavonol, flavan-3-ol, aurone, chalcone, dihydrochalcone and quercetin.

These compounds may be used singly or in combination. Among them, polyphenol compounds are preferable, and catechin, resorcine and the like are most preferable.

Among the water-soluble aromatic compounds, from the viewpoint of excellent water-solubility, those having two or more polar groups are preferable, those having three or more are more preferable, and those having four or more are most preferable.

The polar group is not particularly limited and can be appropriately selected depending on the intended purpose; examples include hydroxyl, carboxyl, carbonyl and sulfonyl groups.

The content of the water-soluble aromatic compound in the resist pattern thickening material can be appropriately determined according to the type, content, etc. of the compound represented by the general formula (1), phase transfer catalyst, surfactant, etc.

### —Organic Solvent—

The organic solvent is not particularly limited and can be appropriately selected depending on the intended purpose; examples include alcohol organic solvents, linear ester organic solvents, cyclic ester organic solvents, ketone organic solvents, linear ether organic solvents and cyclic ether organic solvents.

If the resist pattern thickening material comprises such an organic solvent, it is advantageous in that the solubility of the compound represented by the general formula (1), the resin, etc., increases in the resist pattern thickening material.

The organic solvent can be mixed with water for use. Suitable examples of water are pure water (deionized water), for example.

Examples of the alcohol organic solvents include methanol, ethanol, propyl alcohol, isopropyl alcohol and butyl alcohol.

Examples of the linear ester organic solvents include ethyl lactate and propylene glycol methyl ether acetate (PGMEA).

Examples of the cyclic ester organic solvents include lactone organic solvents such as γ-butyrolactone.

Examples of the ketone organic solvents include ketone organic solvents such as acetone, cyclohexanone and heptanone.

Examples of the linear ether organic solvents include ethyleneglycol dimethylether.

Examples of the cyclic ether organic solvents include tetrahydrofuran and dioxane.

These organic solvents may be used singly or in combination. Among them, those with a boiling point of about 80° C. to 200° C. are preferable from the viewpoint of precise performance of resist pattern thickening.

The content of the organic solvent in the resist pattern thickening material can be set according to the type, content, etc. of the resin, compound represented by the general formula (1), phase transfer catalyst, surfactant, etc.

### —Additional Ingredient—

The additional ingredient is not particularly limited as long as the effect of the present invention is not impaired, and thus can be appropriately selected according to the intended purpose. Examples include various types of known additives such as heat/acid generation agents and quenchers of amine type, amide type, and the like.

The content of the additional ingredient in the resist pattern thickening material can be set according to the type, content, etc. of the resin, compound represented by the general formula (1), phase transfer catalyst, surfactant, etc.

### —Coating—

The method for applying the resist pattern thickening material is not particularly limited and can be appropriately selected from known coating methods depending on the intended purpose. A suitable example is spin coating, for example. In the case of spin coating, preferable spin coating conditions are as follows: rotational speed is, for example, about 100 rpm to 10,000 rpm, more preferably 800 rpm to 5,000 rpm; and spin time is, for example, about 1 second to 10 minutes, more preferably about 1 second to 90 seconds.

The thickness of coating is usually about 100 Å to 10,000 Å (10 nm to 1,000 nm), preferably about 1,000 Å to 5,000 Å (100 nm to 500 nm).

Note that the foregoing surfactant may be previously applied before application of the resist pattern thickening material, rather than adding it to the resist pattern thickening material.

### —Heating—

Heating (baking) is preferably conducted upon or after the coating step. By baking (heating and drying) the resist pattern thickening material applied, the resist pattern thickening material efficiently infiltrates, or is mixed with, a resist pattern at their interface, allowing reactions to proceed efficiently in those mixed portions (portions infiltrated with the resist pattern thickening material).

The heating (baking) method, conditions, etc., are not particularly limited and can be appropriately selected or determined depending on the intended purpose. The heating temperature, however, is preferably below the fluidization temperature of the thickened resist pattern—a temperature at which the thickened resist pattern is fluidized.

If the heating temperature is equal to or greater than this fluidization temperature, this not only softens the thickened resist pattern, but also makes the thickened resist pattern insoluble, leaving residual mass at positions where a resist space pattern is to be formed. Thus it may result in development failure.

The method of determining the fluidization temperature of the thickened resist pattern will be described below. This fluidization temperature is dependent on the constituent material of the resist pattern and on the resist pattern thickening material and thus cannot be determined flatly. However, the temperature at which the resist pattern that has been thickened by means of the resist pattern thickening material is softened and fluidized (i.e., the temperature at which fluidization size (c) as determined and defined as described below generally satisfies the condition c≧1 (nm)) is considered the fluidization temperature of the thickened resist pattern.

### Measurement Method

(1) The thickened resist pattern size is determined by measuring the width of 5 or more lines in the same exposure region and averaging the width values. For this measurement, an electron microscope that is generally used for semiconductors as a CD-SEM, such as S-9260 manufactured by Hitachi Ltd, is used.

### (2) In accordance with (1), the size of the resist space pattern formed by means of the thickened resist pattern (hereinafter referred to as “thickened resist space pattern size” in some cases) is measured (initial value (a)).

(3) A thickened resist pattern that is identical in size to the thickened resist pattern of (2) and present in the same wafer is subjected to heating (thermal flow) treatment to be described later at a given temperature for a given time, and the thickened resist space pattern size is determined as in (1) to obtain a width average (b) of the space pattern.

### (4) The fluidization size (c) is then calculated by subtracting (b) from (a).

The heating temperature is preferably 70° C. or greater and less than 140° C., more preferably 90° C. or greater and less than 120° C.

The heating time is about 10 seconds to 5 minutes, more preferably 40 seconds to 100 seconds.

### —Development—

It is preferable to perform development after the heating (baking) step. In this development, among the portions of the applied resist pattern thickening material, portions that were not interacted (mixed) with the resist pattern and portions that offered weak interaction (mixing) with the resist pattern (i.e., portions with a high water solubility) are developed off, whereby a thickened resist pattern can be obtained.

The developer that can be used in the development step is not particularly limited; water, alkali developers and the like are preferable, which may contain a surfactant as needed. Examples of such alkali developers include tetramethylammoniumhydroxide (TMAH).

The development method is not limited and can be appropriately selected; suitable examples are dipping, paddling, spraying, and the like. Among these methods, paddling is most preferable in view of excellent mass productivity.

Also, the development time is not also limited and can be appropriately set; the development time is preferably 10 seconds to 300 seconds, more preferably 30 seconds to 90 seconds.

Through the above process the resist pattern is thickened uniformly and efficiently by means of the resist pattern thickening material, resulting in the formation of a finer resist space pattern.

It is possible to make the thickened amount of the resist pattern fall within a desired range by appropriately adjusting the viscosity of the resist pattern thickening material, thickness of the coated film, heating (baking) temperature, heating (baking) time, etc.

### <Heating Step>

The heating step is directed to further heat (bake) a resist pattern that has been thickened in the resist pattern thickening step, and is referred to as thermal flow.

The condition under which the heating step (thermal flow baking) is conducted is not particularly limited and can be appropriately determined depending on the intended purpose; however, it is preferable to set an optimal condition according to the resist pattern material and resist pattern thickening material.

The heating temperature in the heating step (thermal flow baking) is not particularly limited and can be appropriately set depending on the intended purpose; however, the heating temperature is preferably equal to or greater than the fluidization temperature of the thickened resist pattern. In this case, when the thickened resist pattern is heated, the resin—a constituent material—is fluidized and thus the space width is further narrowed.

The method of determining the fluidization temperature of the thickened resist pattern will be described below. This fluidization temperature is dependent on the constitutional material of the resist pattern and on the resist pattern thickening material and thus cannot be determined flatly. However, the temperature at which the resist pattern thickened by means of the resist pattern thickening material is softened and fluidized, i.e., the temperature at which fluidization size (c) as determined and defined as described below generally satisfies the condition c≧1 (nm), is considered the fluidization temperature of the thickened resist pattern.

### Measurement Method

(1) The thickened resist pattern size is determined by measuring the width of 5 or more lines in the same exposure region and averaging the width values. For this measurement, an electron microscope that is generally used for semiconductors as a CD-SEM, such as S-9260 manufactured by Hitachi Ltd is used.

### (2) In accordance with (1), the size of the resist space pattern formed by means of the thickened resist pattern (hereinafter referred to as “thickened resist space pattern size” in some cases) is measured (initial value (a)).

(3) A thickened resist pattern that is identical in size to the thickened resist pattern of (2) and present in the same wafer is subjected to a heating (thermal flow) treatment at a given temperature for a given time, and the thickened resist space pattern size is determined as in (1) to obtain a width average (b) of the space pattern.

### (4) The fluidization size (c) is then calculated by subtracting (b) from (a).

The heating temperature is preferably 140° C. to 180° C., more preferably 150° C. to 170° C. and, most preferably, 160° C. to 170° C.

If the heating temperature is below 140° C., the thickened resist pattern resin may not be fluidized, whereas if it exceeds 180° C., it may result in the excessive deformation of the pattern shape—deformation (blunting) of the upper edges of the resist pattern, reduction in the resist pattern thickness, etc—and in the deterioration of the resist resin to increase the amount of residual mass when etched.

Meanwhile, the heating time is dependent on the amount of reduction of the resist space it takes to obtain a desired size, and can be appropriately set while taking the heating temperature into consideration. However, the heating time is preferably 10 seconds to 180 seconds, more preferably 30 seconds to 90 seconds and, most preferably, 60 seconds.

If the heating time is longer than 180 seconds, it may also result in the excessive deformation of the pattern shape—deformation (blunting) of the upper edges of the resist pattern, reduction in the resist pattern thickness, etc—and in the deterioration of the resist resin to increase the amount of residual mass when etched.

The heating method is not particularly limited and can be appropriately selected depending on the intended purpose; a hot plate, a furnace or the like can be suitably used. Of the two, the hot plate, which is generally used in the semiconductor process, is preferable and a hot plate capable of precise control of temperature and time is most preferable.

The atmosphere in the heating step is not particularly limited and can be appropriately selected depending on the intended purpose; however, the heating step is preferably conducted in the Earth's atmosphere or in a nitrogen atmosphere.

Through the above process the resin of the thickened resist pattern is fluidized and thus the resist spaces formed by means of the thickened resist pattern are reduced in width with good precision.

Next, the process of the present invention for forming a resist pattern will be described with reference to the drawings.

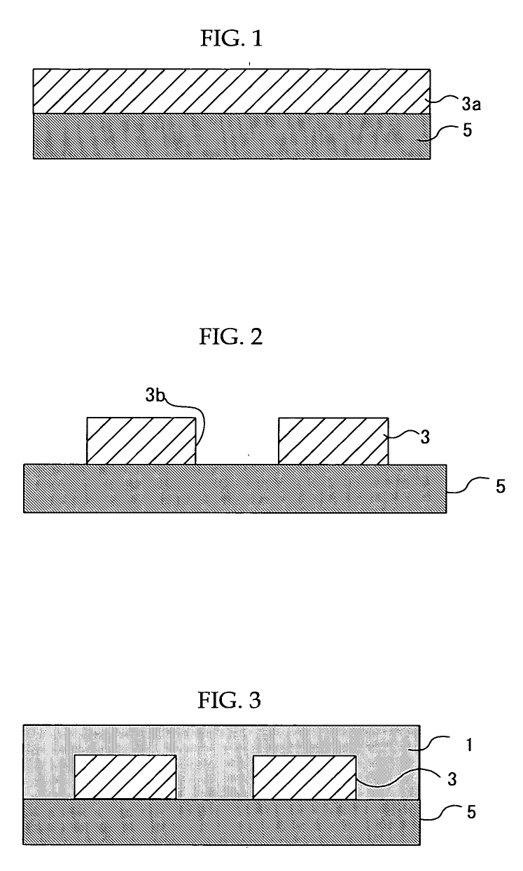

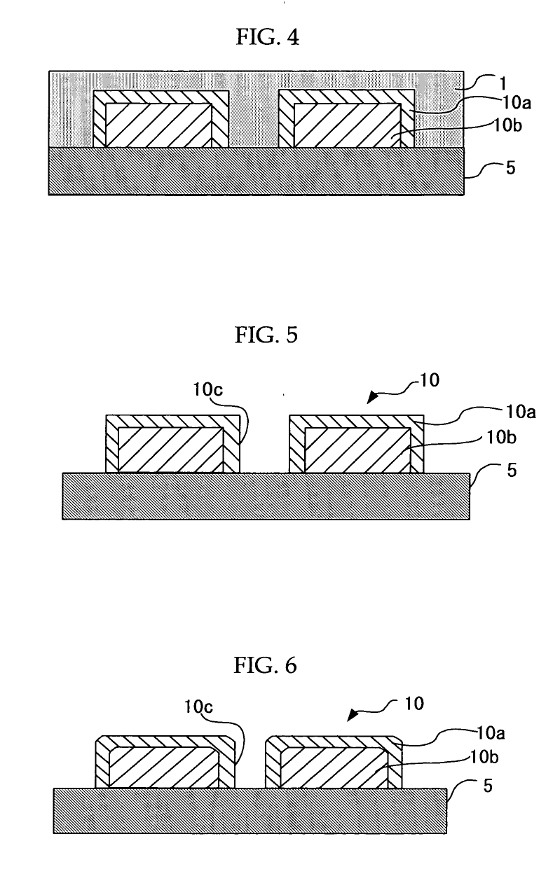

After applying a resist material 3a over a surface of a workpiece (base) 5 as shown in FIG. 1, the resist material 3a is patterned by etching to form a resist pattern 3 as shown in FIG. 2. Subsequently, as shown in FIG. 3, a resist pattern thickening material 1 is applied over the resist pattern 3, followed by baking (heating and drying) to form a coated film. An interaction (mixing) then occurs between the resist pattern 3 and resist pattern thickening material 1 at their interface and, as shown in FIG. 4, reactions take place there. When development is conducted as shown in FIG. 5, in the resist pattern thickening material 1, portions that were not reacted with the resist pattern 3 and portions that offered weak interaction (mixing) with the resist pattern 3 (i.e., portions with a high water solubility) are developed off, thereby forming a thickened resist pattern 10 consisting of an inner resist pattern 10b (resist pattern 3) and a surface layer 10a. This is the resist pattern thickening step described above.

The thickened resist pattern 10 is one thickened by means of the resist pattern thickening material 1 and has the surface layer 10a over the surface of the inner resist pattern 10b (resist pattern 3), which the surface layer 10a formed by reaction with the resist pattern thickening material 1. Since the resist pattern thickening material 1 contains a compound represented by the general formula (1), the resist pattern 10 is uniformly thickened regardless of the size, constituent material, etc., of the resist pattern 3. Since the thickened resist pattern 10 is larger in size than the resist pattern 3 (inner resist pattern 10b) by an amount corresponding to the thickness of surface layer 10a, the resist space pattern 10c formed by the thickened resist pattern 10 is smaller in width than the resist space pattern 3b (see FIG. 2) formed by the resist pattern 3 (inner resist pattern 10b), and thus the resist space pattern 10c formed by the thickened resist pattern 10 is fine.

The surface layer 10a of the thickened resist pattern 10 is formed of the resist pattern thickening material 1, and the compound represented by the general formula (1) therein has an aromatic ring. For this reason, even when the resist pattern 3 (inner resist pattern 10b) is made of material that offers poor etching resistance, it is possible to prepare a thickened resist pattern 10 with a surface layer (mixing layer) 10a having excellent etching resistance. Moreover, when the resist pattern thickening material 1 contains resin, a part of which has the foregoing cyclic structure(s), the etching resistance of the surface layer (mixing layer) 10a is further increased.

When the thickened resist pattern 10 is further heated, the resin in the thickened resist pattern 10 is fluidized and, as shown in FIG. 6, the width of the resist space pattern 10c formed by the thickened resist pattern 10 is reduced, thereby further reducing the width of the resist space pattern 3b (see FIG. 2) formed by the resist pattern 3 (inner resist pattern 10b). This is the heating step described above.

The resist pattern prepared by the process of the present invention (hereinafter referred to as “thickened resist pattern” in some cases) is larger in size than the foregoing resist pattern 3 by an amount corresponding to the thickness of the surface layer (mixing layer) formed, and the resin constituting the resist pattern is fluidized through the heating step (thermal flow). Thus, the resist space pattern 10c formed by the thickened resist pattern 10 is smaller in size (e.g., diameter and width) than the resist space pattern 3b formed by the resist pattern 3. With the process of the present invention for forming a resist pattern, it is therefore possible to produce a fine resist space pattern efficiently.

The thickened resist pattern preferably has high etching resistance. It is preferable that the etching rate (nm/min) of the thickened resist pattern be equal to or less than that of the resist pattern 3. To be more specific, the ratio of the etching rate (nm/min) of the resist pattern 3 to that of the surface layer (mixing layer), as determined under the same condition, is preferably 1.1 or more, more preferably 1.2 or more, and most preferably 1.3 or more.

The etching rate (nm/min) can be determined, for example, by measuring the reduction in the amount of a sample film after etching it for a predetermined time using a conventional etching device and by calculating the reduction amount per unit time.

The process of the present invention for forming a resist pattern is suitable for the formation a variety of space patterns, including line-space pattern, hole pattern (e.g., for contact holes), trenches, etc. The thickened resist pattern formed by this process can be used as a mask pattern, reticle pattern and the like and can be employed for the manufacture of functional parts such as metal plugs, interconnections, magnetic heads, LCDs (liquid crystal displays), PDPs (plasma display panels) and SAW filters (surface acoustic wave filters); optical parts used in connecting optical interconnections; fine parts such as micro-actuators; semiconductor devices; and the like. Also, the thickened resist pattern can be suitably employed in the manufacture of a semiconductor device of the present invention, which will be described hereinafter.

### (Semiconductor Device and Manufacturing Method)

The method of the present invention for manufacturing a semiconductor device comprises a resist pattern forming step and a patterning step, and further comprises additional step(s) suitably selected where necessary.

The semiconductor device of the present invention is manufactured with the method of the present invention for manufacturing a semiconductor device.

Hereinafter, the details of the semiconductor device of the present invention will also be provided through the following description of the method of the present invention for manufacturing a semiconductor device.

### <Resist Pattern Forming Step>

The resist pattern forming step is one for forming a resist pattern on a surface of a workpiece by the process of the present invention for forming a resist pattern. Through this resist pattern forming step, a thickened resist pattern is formed on the workpiece and the resin constituting the pattern is fluidized, resulting in the formation of a fine resist space pattern.

This resist pattern forming step is identical to the resist pattern forming step of the present invention described above, and the resist pattern is also identical to that described above.

As the surface of a workpiece, surface layers of various parts of a semiconductor device can be exemplified; specific suitable examples include substrates such as silicon wafers or the surface thereof, and low permittivity films such as various types of oxide films or the surface thereof.

The low permittivity films are not particularly limited and can be appropriately selected; however, those with a specific permittivity of 2.7 or less are preferable. Suitable examples of such low permittivity films include porous silica films and fluorinated resin films.

The porous silica film can be prepared by, for example, applying a silica film-forming material and drying the solvent by heat treatment followed by firing.

In a case where the fluorinated resin film is a fluorocarbon film, this film can be prepared by, for example, depositing a mixture gas of C₄F₈ and C₂H₂ or C₄F₈ gas by RF-CVD (power=400 W).

### <Patterning Step>

The patterning step is one for patterning the surface of the workpiece by etching while using the resist pattern (thickened resist pattern) formed in the resist pattern forming step as a mask (mask pattern) or the like.

The etching method is not particularly limited and can be appropriately selected from those known in the art depending on the intended purpose. For example, dry etching is suitably exemplified. Also, there is no particular limitation on the etching condition, and an appropriate condition can be selected according to the intended purpose.

### <Additional Step>

Examples of the additional step include a surfactant applying step.

The surfactant applying step is one for applying a surfactant on the surface of the resist pattern prior to the application of the resist pattern thickening material thereon.

The surfactant is not particularly limited and can be appropriately selected depending on the intended purpose. Suitable examples include those listed above, polyoxyethylene-polyoxypropylene condensation products, polyoxyalkylene alkylether compounds, polyoxyethylene alkylether compounds, polyoxyethylene derivative compounds, sorbitan fatty acid ester compounds, glycerin fatty acid ester compounds, primary alcohol ethoxylate compounds, phenol ethoxylate compounds, nonylphenol ethoxylates, octylphenol ethoxylates, lauryl alcohol ethoxylates, oleyl alcohol ethoxylates, fatty acid esters, amides, natural alcohols, ethylene diamines, secondary alcohol ethoxylates, alkyl cations, amide quaternary cations, ester quaternary cations, amine oxides, and betaines.

According to the method of the present invention for manufacturing a semiconductor device, various types of semiconductor devices including logic devices, flash memories, DRAMs, and FRAMs can be efficiently manufactured.

### EXAMPLES

Hereinafter, Examples of the present invention will be described, which however shall not be construed as limiting the invention thereto. Note in Examples that “part(s)” means “part(s) by mass” unless otherwise indicated.

### Example 1

### —Preparation of Resist Pattern Thickening Material—

A resist pattern thickening material containing the following ingredients was prepared:

### (1) Polyvinyl alcohol resin (“PVA-205C” by KURARAY Co., Ltd.)

. . . 4 parts

### (2) 2-Hydroxybenzyl alcohol (by Aldrich)

### . . . 1 Part

### (3) Surfactant (“TN-80” by ADEKA)

### . . . 0.06 Parts

### (4) Purified water

### . . . 96 Parts

### —Formation of Resist Pattern—

### <Resist Pattern Thickening Step>

An ArF acrylic resist (“AR1244J” by JSR) of 220 nm thickness was applied on an 8-inch silicon substrate (manufactured by Shin-Etsu Chemical Co., Ltd.) on which an antireflective film (“ARC-39” by Nissan Chemical Industries, Ltd.) had been formed by coating. The ArF acrylic resist was exposed to ArF excimer laser using an ArF excimer exposure device to form a hole pattern with an initial pattern size of about 94 nm (pitch=200 nm).

The resist pattern thickening material prepared above was applied on the hole pattern by spin coating at 1,000 rpm for 5 seconds and then at 3,500 rpm for 40 seconds, followed by baking at 110° C. for 60 seconds. Thereafter, the resist pattern thickening material was rinsed with purified water for 60 seconds to remove non-reacted portions, or non-interacted (non-mixed) portion, for development. In this way a thickened resist pattern was produced.

The size of the resist space pattern formed by the thickened resist pattern, as measured in the manner described below, was 77.6 nm, revealing that this resist space pattern is 16.2 nm smaller in size (width) than the initial resist space pattern, a resist space pattern formed by the resist pattern before thickened.

### <Heating Step>

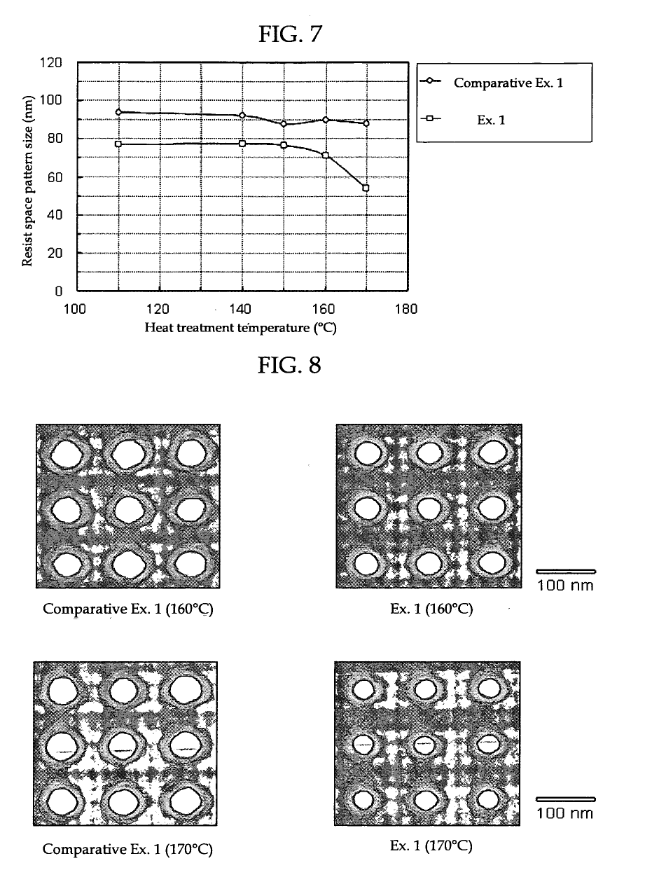

The thickened resist pattern thus formed was further heated. Silicon substrates provided with the foregoing thickened resist pattern were prepared, and respectively heated to 140° C., 150° C., 160° C. and 170° C. for 60 seconds, followed by measurement of the size of each resist space pattern resulted from the heated thickened resist pattern in the following manner. The results are shown in Table 1 and FIG. 7.

### Measurement Method

(1) The thickened resist pattern size is determined by measuring the width of 5 or more lines in the same exposure region and averaging the width values. For this measurement, an electron microscope that is generally used for semiconductors as a CD-SEM, such as S-9260 manufactured by Hitachi Ltd is used.

### (2) In accordance with (1), the size of the resist space pattern formed by means of the thickened resist pattern (hereinafter referred to as “thickened resist space pattern size” in some cases) is measured (initial value (a)).

(3) A thickened resist pattern that is identical in size to the thickened resist pattern of (2) and present in the same wafer is subjected to heating (thermal flow) treatment to be described later at a given temperature for a given time, and the thickened resist space pattern size is determined as in (1) to obtain a width average (b) of the space pattern.

### (4) The fluidization size (c) is then calculated by subtracting (b) from (a).

In this Example the thickened resist pattern was slightly fluidized when baked at 140° C., and the fluidization size (c) satisfied the condition c≧1 (nm) when baked at 150° C. or higher, suggesting that the thickened resist pattern was greatly fluidized at those temperatures.

TABLE 1

| | Heat treatment temperature (° C.) | | | |
|---|---|---|---|---|
| | 140 | 150 | 160 | 170 |
| Initial resist space pattern size (nm) | 93.8 | | | |
| Thickened resist space pattern size | 77.6(Initial value (a)) | | | |
| Before heat treatment (nm) | | | | |
| Thickened resist space pattern size | 77.4 | 76.6 | 70.8 | 54 |
| After heat treatment (nm)(=b) | | | | |
| c(nm)(=a − b) | 0.2 | 1 | 6.8 | 23.6 |

### Comparative Example 1

A resist pattern was prepared as in Example 1 except that the resist pattern was not thickened by means of the resist pattern thickening material before subjecting it to the heating step. Note also that silicon substrates provided with a resist pattern were prepared as in Example 1, and respectively heated to 140° C., 150° C., 160° C. and 170° C. for 60 seconds for subsequent measurement of the size of each resist space pattern resulted from the heated resist pattern. The results are shown in Table 2 and FIG. 7.

TABLE 2

| | Heat treatment temperature (° C.) | | | |
|---|---|---|---|---|
| | 140 | 150 | 160 | 170 |
| Initial resist space pattern size (nm) | 93.8 | | | |
| Resist space pattern size | 92.2 | 87.6 | 89.6 | 87.8 |
| after heat treatment (nm) | | | | |

### —Measurement of Amount of Reduction of Resist Space Pattern Size—

As shown in FIG. 7, the space pattern of the thickened resist pattern prepared in Example 1 decreases in size with increasing heating temperature from near 140° C., showing a resist space pattern size of 54 nm when heated to 170° C. That is, while the amount of reduction of the space pattern size—the resist space pattern size of the freshly thickened resist pattern (prior to heat treatment) minus the resist space pattern size after heat treatment—was 23.6 nm, the resist space pattern size of the resist pattern before treated with the resist pattern thickening material minus the resist space pattern size after heat treatment was 39.8 nm.

The resist space pattern size of the resist pattern of Comparative Example 1, which had not been thickened using the resist pattern thickening material, was reduced only to 87.7 nm even when heated to 170° C., which means that the amount of reduction was 6 mm.

The net result of the foregoing reveals that the diameters of holes (hole pattern diameter) can be efficiently reduced when the resist pattern is treated with the resist pattern thickening and then subjected to heat treatment (thermal flow). This cannot be achieved only the resist pattern thickening material.

### —Evaluation of Resist Pattern Shape—

The shapes of holes, when viewed from above, of the thickened resist pattern of Example 1 and resist pattern of Comparative Example 1 after 160° C. and 170° C. heat treatments were observed using a scanning electron scope (“S-6100” by Hitachi Ltd.) at 1,500,000× magnification. The SEM pictures of these hole patterns are shown in FIG. 8.

In the SEM pictures shown in FIG. 8, a whitish area present around the periphery of each hole corresponds to deformation (blunting) of the upper edge of the resist pattern as shown in FIGS. 18A and 18B. The larger width of the blunt edge means greater degree of edge deformation. It was found that, as shown in FIG. 8, the whitish areas of Comparative Example 1 are larger than those of Example 1 and that the degree of deformation is high in Comparative Example 1.

The width of the blunt edge of each hole heated to 170° C. was measured to be 14 nm in Example 1 and 28 nm in Comparative example 1, which means that the degree of deformation is reduced to half in Example 1. This may be attributed to the fact that the resist pattern thickening material contains a benzyl alcohol compound represented by the general formula (1) and thus offers excellent heat resistance sufficient to prevent resist fluidization.

### Example 2

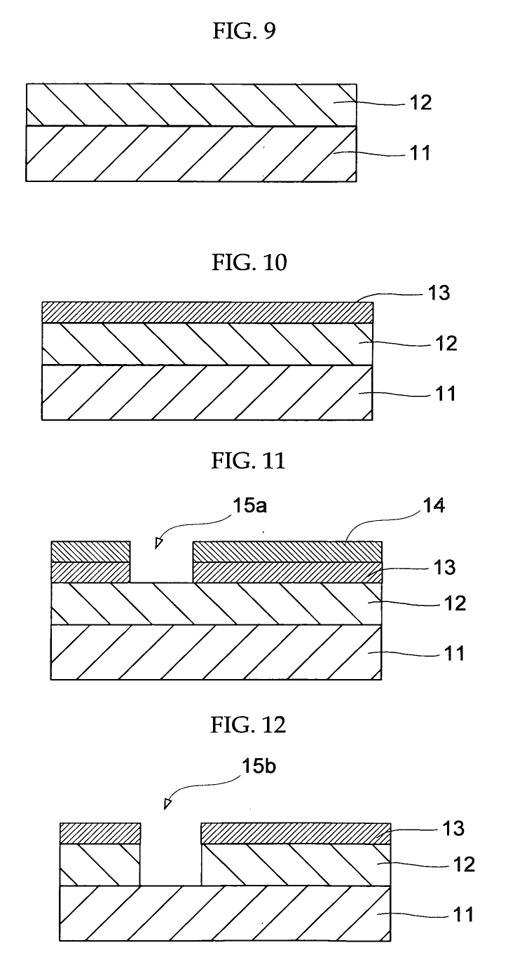

As shown in FIG. 9, an interlayer dielectric film 12 was formed on a silicon substrate 11 and, as shown in FIG. 10, a titanium film 13 was formed on the interlayer dielectric film 12 by sputtering. Next, as shown in FIG. 11, a resist pattern 14 was formed by known photolithography and the titanium film 13 was patterned via reactive ion etching while using the resist pattern 14 as a mask, forming an opening 15a. Subsequently, the resist pattern 14 was removed by reactive ion etching and, as shown in FIG. 12, an opening 15b was formed in the interlayer dielectric film 12 while using the titanium film 13 as a mask.

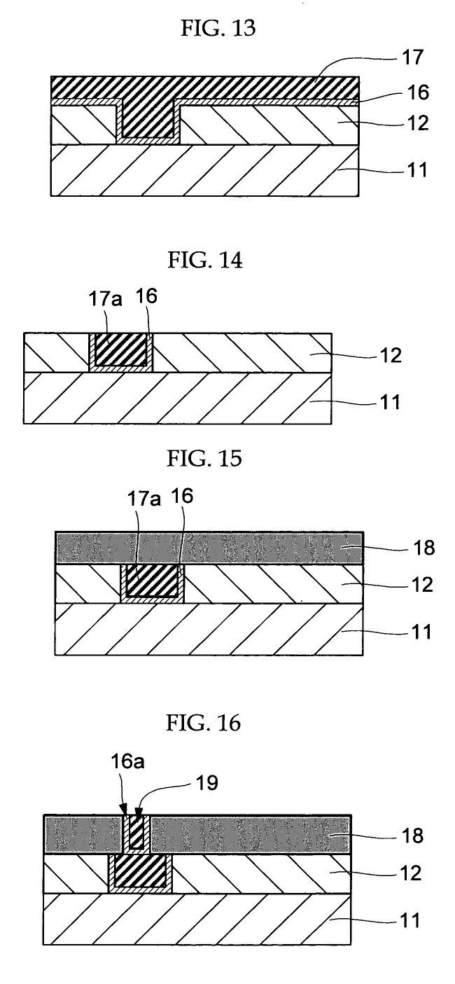

The titanium film 13 was removed by wet process and, as shown in FIG. 13, a TiN film 16 was formed on the interlayer insulating film 12 by sputtering, followed by deposition of a Cu film 17 on the TiN film 16 by electroplating. As shown in FIG. 14, chemical and mechanical polishing (CMP) was then performed, leaving barrier metal and a Cu film (first metal film) only in the trench, which is the opening 15b shown in FIG. 12, to form a first interconnection layer 17a.

After forming an interlayer dielectric film 18 on the first interconnection layer 17a as shown in FIG. 15, a Cu plug (second metal film) 19 and a TiN film 16a, both of which serve to connect the first interconnection layer 17a to another interconnection layer to be formed above, were formed in a manner similar to that shown in FIGS. 9 to 16, as shown in FIG. 6.

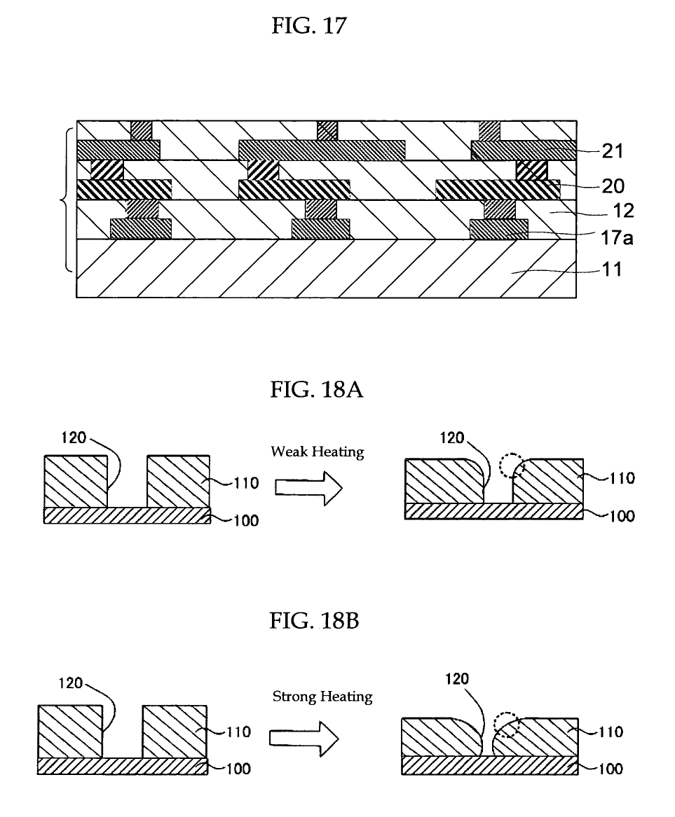

By repeating this process, as shown in FIG. 17, a semiconductor device was manufactured that has a multilayer interconnection structure in which the first interconnection layer 17a, a second interconnection layer 20 and a third interconnection layer are formed on the silicon substrate 11. Note in FIG. 17 that the barrier metal layer formed at the bottom of each interconnection layer is not illustrated.

In Example 2 the resist pattern 14 is a thickened resist pattern prepared by using the resist pattern thickening material prepared in Example 1 and subjected to 160° C. heat treatment as in Example 1.

The interlayer dielectric film 12 is a low permittivity film with a specific permittivity of 2.7 or less; examples include a porous silica film (“Ceramate NCS” by Catalysts & Chemicals Industries Co., Ltd., permittivity=2.25); and a fluorocarbon film (permittivity=2.4) prepared by depositing a mixture gas of C₄F₈ and C₂H₂ or C₄F₈ gas by RF-CVD (power=400 W).

According to the present invention, it is possible to solve the conventional problems and to achieve the object described above.

In addition, according to the present invention, it is possible to provide a process for forming a resist pattern, which the process can adopt even ArF excimer laser light as exposure light in a patterning step, can thicken a resist pattern (e.g., a hole pattern) regardless of its size, and can reduce the size of a resist space pattern with high precision while preventing changes in the resist pattern shape, to thereby make this process easy, inexpensive and efficient while exceeding the exposure (resolution) limits of light sources of exposure devices.

According to the present invention, it is also possible to provide (1) a method for manufacturing a semiconductor device, which the method can adopt even ArF excimer laser light as exposure light in a patterning step, can reduce the size of a resist space pattern with high precision while exceeding the exposure (resolution) limits of light sources of exposure devices, and can manufacture high-performance semiconductor devices with a fine interconnection pattern in large quantities, and (2) a semiconductor device manufactured by the method.

For example, the process of the present invention for forming a resist pattern can be used for the production of mask patterns, reticle patterns and the like and for the manufacture of functional parts such as metal plugs, interconnections, magnetic heads, LCDs (liquid crystal displays), PDPs (plasma display panels) and SAW filters (surface acoustic wave filters); optical parts used in connecting optical interconnections; fine parts such as micro-actuators; semiconductor devices; and the like. Also, this process can be suitably employed in the method of the present invention for manufacturing a semiconductor device.

The method of the present invention for manufacturing a semiconductor device can be suitably used for the manufacture of various types of semiconductor devices including logic devices, flash memories, DRAMs, and FRAMs.

What is claimed is:

1. A process for forming a resist pattern, comprising:
forming a resist pattern;
applying over a surface of the resist pattern a resist pattern thickening material;
heating the resist pattern thickening material to thicken the resist pattern followed by development; and
heating the resist pattern which has been thickened,
wherein the resist pattern thickening material comprises a resin and a compound represented by the following general formula (1): 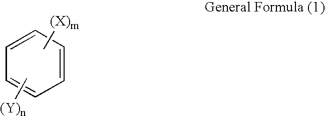
where X is a functional group represented by the following structural formula (1), Y is at least one of hydroxyl group, amino group, alkyl group-substituted amino group, alkoxy group, alkoxycarbonyl group and alkyl group and the number of the substituents is an integer of 0 to 3, m is an integer of 1 or greater, and n is an integer of 0 or greater 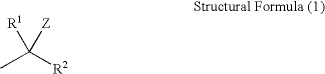
where R¹ and R² may be identical or different and each is a hydrogen atom or substituent, Z is at least one of hydroxyl group, amino group, alkyl group-substituted amino group and alkoxy group and the number of the substituents is an integer of 0 to 3.

2. The process for forming a resist pattern according to claim 1, wherein the heating upon thickening of the resist pattern is conducted at a temperature below the fluidization temperature of the resist pattern after thickened.

3. The process for forming a resist pattern according to claim 2, wherein the heating temperature upon thickening of the resist pattern is 70° C. or greater and less than 140° C.

4. The process for forming a resist pattern according to claim 1, wherein the heating after thickening of the resist pattern is conducted at a temperature equal to or greater than the fluidization temperature of the resist pattern after thickened.

5. The process for forming a resist pattern according to claim 4, wherein the heating temperature after thickening of the resist pattern is 140° C. to 180° C.

6. The process for forming a resist pattern according to claim 1, wherein the resist pattern thickening material is water soluble or alkali soluble.

7. The process for forming a resist pattern according to claim 1, wherein the development is conducted using at least one of purified water and an alkali developer.

8. The process for forming a resist pattern according to claim 1, wherein the resist pattern is formed of at least one of an ArF resist and a resist containing acrylic resin

9. The process for forming a resist pattern according to claim 8, wherein the ArF resist is at least one selected from the group consisting of an acrylic resist having an alicyclic functional group on its side chain, a cycloolefin-maleic acid anhydride resist and a cycloolefin resist.

10. The process for forming a resist pattern according to claim 1, wherein resin constituting the resist pattern thickening material is at least one selected from the group consisting of polyvinyl alcohol, polyvinyl acetal and polyvinyl acetate.

11. The process for forming a resist pattern according to claim 1, wherein “m” is 1 in the general formula (1) representing the compound contained in the resist pattern thickening material.

12. A method for manufacturing a semiconductor device, comprising:
forming a resist pattern on a surface of a workpiece; and
patterning the surface of the workpiece by etching using the resist pattern as a mask,
wherein the forming of the resist pattern comprises:
forming the resist pattern;
applying over a surface of the resist pattern a resist pattern thickening material;
heating the resist pattern thickening material to thicken the resist pattern followed by development; and
heating the resist pattern which has been thickened,
wherein the resist pattern thickening material comprises a resin and a compound represented by the following general formula (1): 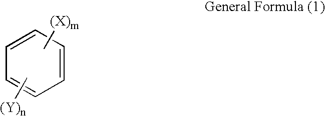
where X is a functional group represented by the following structural formula (1), Y is at least one of hydroxyl group, amino group, alkyl group-substituted amino group, alkoxy group, alkoxycarbonyl group and alkyl group and the number of the substituents is an integer of 0 to 3, m is an integer of 1 or greater, and n is an integer of 0 or greater 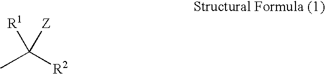
where R¹ and R² may be identical or different and each is a hydrogen atom or substituent, Z is at least one of hydroxyl group, amino group, alkyl group-substituted amino group and alkoxy group and the number of the substituents is an integer of 0 to 3.

13. The method for manufacturing a semiconductor device according to claim 12, wherein the surface of the workpiece is a surface of a low permittivity film with a specific permittivity of 2.7 or less.

14. The method for manufacturing a semiconductor device according to claim 13, wherein the low permittivity film is at least one of a porous silica film and a fluorinated resin film.

15. A semiconductor device manufactured by a method for manufacturing a semiconductor device,
wherein the method comprises:
forming a resist pattern on a surface of a workpiece; and
patterning the surface of the workpiece by etching using the resist pattern as a mask,
wherein the forming of the resist pattern comprises:
forming the resist pattern;
applying over a surface of the resist pattern a resist pattern thickening material;
heating the resist pattern thickening material to thicken the resist pattern followed by development; and
heating the resist pattern which has been thickened,
wherein the resist pattern thickening material comprises a resin and a compound represented by the following general formula (1): 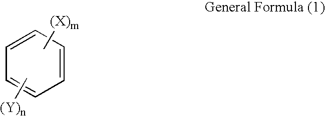
where X is a functional group represented by the following structural formula (1), Y is at least one of hydroxyl group, amino group, alkyl group-substituted amino group, alkoxy group, alkoxycarbonyl group and alkyl group and the number of the substituents is an integer of 0 to 3, m is an integer of 1 or greater, and n is an integer of 0 or greater 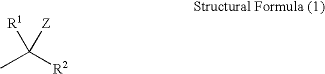
where R¹ and R² may be identical or different and each is a hydrogen atom or substituent, Z is at least one of hydroxyl group, amino group, alkyl group-substituted amino group and alkoxy group and the number of the substituents is an integer of 0 to 3.

16. The semiconductor device according to claim 15, wherein the semiconductor device comprises a low permittivity film with a specific resistance of 2.7 or less.

17. The semiconductor device according to claim 16, wherein the low permittivity film is at least one of a porous silica film and a fluorinated resin film.
